(19) United States
(12) Patent Application Publication
(10) Pub. No.: US 2024/0086861 A1
(43) Pub. Date: Mar. 14, 2024

(54) NON-TRANSITORY COMPUTER READABLE MEDIUM AND INFORMATION PROCESSING SYSTEM

(71) Applicant: FUJIFILM Business Innovation Corp., Tokyo (JP)

(72) Inventor: Hiroki Honjo, Kanagawa (JP)

(73) Assignee: FUJIFILM Business Innovation Corp., Tokyo (JP)

(21) Appl. No.: 18/179,489

(22) Filed: Mar. 7, 2023

(30) Foreign Application Priority Data
Sep. 9, 2022 (JP) 2022-143656

(51) Int. Cl. G06Q 10/20

(52) U.S. Cl. CPC G06Q 10/20

(57) ABSTRACT

A non-transitory computer readable medium stores a program causing a computer to execute a process for information processing, the process including: accepting a maintenance instruction for performing maintenance work on a target device which is one of plural physical devices; and permitting a worker who is able to work on plural virtual devices provided one-to-one with the plural physical devices to perform, as the maintenance work, only work on a virtual device corresponding to the target device, and prohibiting the worker from working on a virtual device corresponding to a non-target device other than the target device among the plural physical devices.

### CROSS-REFERENCE TO RELATED APPLICATIONS

This application is based on and claims priority under 35 USC 119 from Japanese Patent Application No. 2022-143656 filed Sep. 9, 2022.

### BACKGROUND

### (i) Technical Field

The present disclosure relates to a non-transitory computer readable medium and an information processing system.

### (ii) Related Art

Japanese Unexamined Patent Application Publication No. 2005-332093 discloses a maintenance work system management apparatus for managing a maintenance work system including one or more to-be-maintained devices and one or more terminal devices for persons in charge of the work. The maintenance work system management apparatus includes a memory for storing, for each to-be-maintained device, work permission information necessary for permitting maintenance work. In addition, the maintenance work system management apparatus includes an image coder for reading, in response to a request for transmitting work permission information including device identification information identifying a to-be-maintained device, work permission information for a device identified by the device identification information from the memory, and image-coding the work permission information using a certain coding method. The maintenance work system management apparatus also includes a transmitter for transmitting the image-coded information obtained by the image coder to a transmission destination identified based on the transmission request.

A technique for performing, via a virtual device installed on a cloud, maintenance work on a physical device provided one-to-one with the virtual device is assumed. In this case, by working on the virtual device without going to a place where the target device is installed, the worker is able to perform maintenance work on the target device corresponding to the virtual device. However, when this worker is able to work on a plurality of virtual devices, there is a possibility that the worker accidentally works on a virtual device corresponding to a non-target device other than a target device.

### SUMMARY

Aspects of non-limiting embodiments of the present disclosure relate to a non-transitory computer readable medium and an information processing system for preventing a worker who is permitted to work on a plurality of devices from accidentally working on a virtual device corresponding to a non-target device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a non-transitory computer readable medium storing a program causing a computer to execute a process for information processing, the process including: accepting a maintenance instruction for performing maintenance work on a target device which is one of a plurality of physical devices; and permitting a worker who is able to work on a plurality of virtual devices provided one-to-one with the plurality of physical devices to perform, as the maintenance work, only work on a virtual device corresponding to the target device, and prohibiting the worker from working on a virtual device corresponding to a non-target device other than the target device among the plurality of physical devices.

### BRIEF DESCRIPTION OF THE DRAWINGS

An exemplary embodiment of the present disclosure will be described in detail based on the following figures, wherein:

FIG. 1 is a diagram illustrating a schematic configuration of an image forming system according to an exemplary embodiment;

FIG. 2 is a block diagram illustrating the configuration of the major parts of the electrical system of an image forming device in the image forming system according to the present exemplary embodiment;

FIG. 3 is a block diagram illustrating the configuration of the major parts of the electrical system of a cloud server, an administrator terminal, and a communication terminal in the image forming system according to the present exemplary embodiment;

FIG. 4 is a diagram illustrating a situation where a worker is permitted to work on a plurality of virtual devices;

FIG. 5 is a diagram for explaining processing performed in the case where a real device is newly installed;

FIG. 6 is a diagram illustrating the configuration of a worker database;

FIG. 7 is a diagram for explaining processing performed in the case where an administrator instructs the worker to perform maintenance work on a target device;

FIG. 8 is a diagram illustrating the configuration of the worker database storing instruction information;

FIG. 9 is a diagram for explaining the case in which the worker works on a virtual device;

FIG. 10 is a flowchart illustrating an example of the flow of processing performed by the cloud server in the image forming system according to the exemplary embodiment; and

FIG. 11 is a flowchart illustrating a modification of the flow of the processing performed by the cloud server in the image forming system according to the exemplary embodiment.

### DETAILED DESCRIPTION

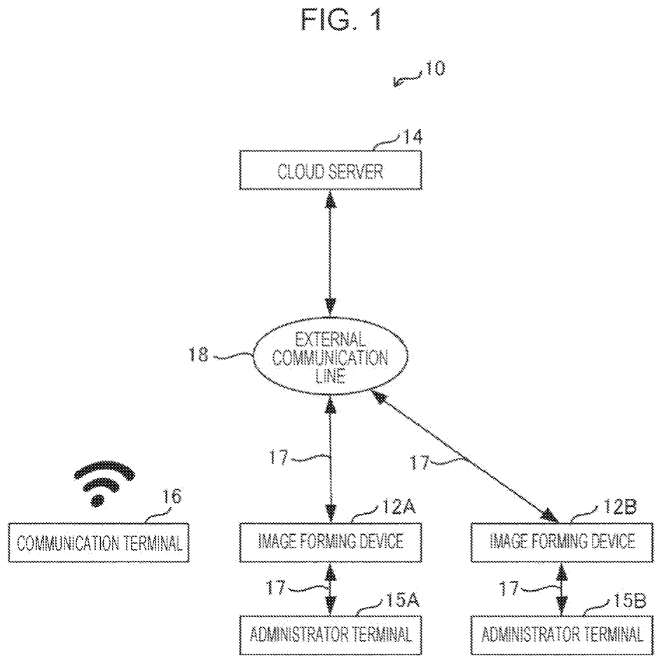

Hereinafter, an exemplary embodiment of the present disclosure will be described in detail with reference to the drawings. FIG. 1 is a diagram illustrating a schematic configuration of an image forming system according to the present exemplary embodiment. In the present exemplary embodiment, an image forming system 10 will be described as an example of an information processing system.

The image forming system 10 according to the present exemplary embodiment includes, as illustrated in FIG. 1, image forming devices 12 as an example of physical devices, a cloud server 14 as an example of an information processing device, administrator terminals 15, and a communication terminal 16. The image forming system 10 includes the plural image forming devices 12A, 12B, . . . . In the example illustrated in FIG. 1, the image forming system 10 includes two image forming devices 12. However, this example is not the only possible case. The image forming system 10 may include more than two image forming devices 12. Hereinafter, the image forming devices 12A, 12B, . . . will be simply and collectively referred to as the “image forming devices 12” when it is unnecessary to distinguish them. Moreover, in the example illustrated in FIG. 1, the image forming system 10 includes an administrator terminal 15A connected to the image forming device 12A, and an administrator terminal 15B connected to the image forming device 12B. However, this example is not the only possible case. The image forming system 10 may include more than two administrator terminals 15. Hereinafter, the administrator terminals 15A, 15B, . . . will be simply and collectively referred to as the “administrator terminals 15” when it is unnecessary to distinguish them. In addition, the number of communication terminals 16 is not limited to the number illustrated in FIG. 1.

The image forming devices 12 and the administrator terminals 15 owned by administrators who manage the image forming devices 12 are connected to internal communication lines 17 such as local area networks (LAN), intranets, or the like. The internal communication lines 17 and the cloud server 14 are connected to an external communication line 18 such as a wide area network (WAN), the Internet, or the like. Moreover, the communication terminal 16 carried by a worker is configured to be connectable to the internal communication lines 17 and the external communication line 18. The image forming devices 12, the cloud server 14, the administrator terminals 15, and the communication terminal 16 are each configured to be able to transmit and receive various types of information to and from each other via the internal communication lines 17 and the external communication line 18. Note that, as examples of the administrator terminals 15 and the communication terminal 16, mobile phones such as smart phones, notebook personal computers (PCs), or the like are applied.

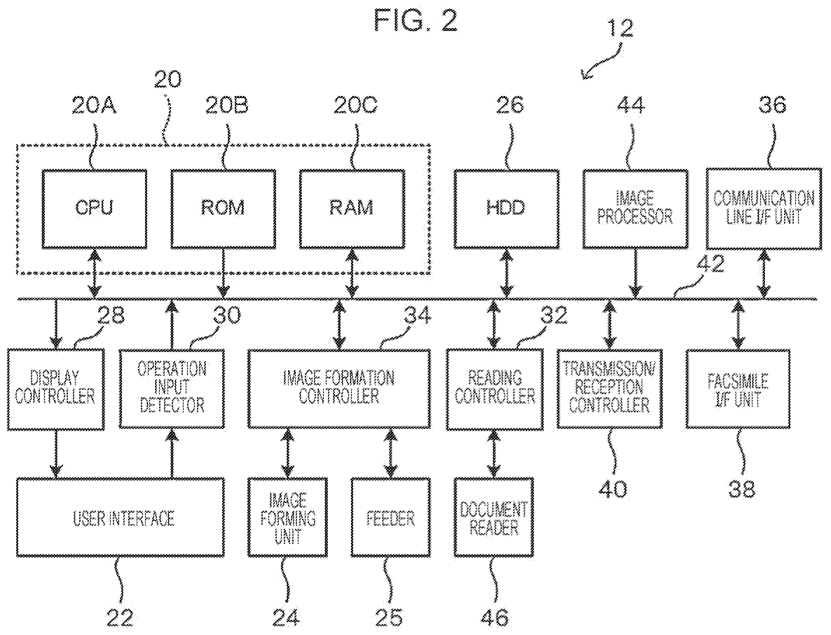

FIG. 2 is a block diagram illustrating the configuration of the major parts of the electrical system of one image forming device 12 in the image forming system 10 according to the present exemplary embodiment.

The image forming device 12 according to the present exemplary embodiment includes, as illustrated in FIG. 2, a control unit 20, which includes a central processing unit (CPU) 20A, a read-only memory (ROM) 20B, and a random-access memory (RAM) 20C. The CPU 20A controls the entire operation of the image forming device 12. The RAM 20C is used as a work area or the like when the CPU 20A executes various programs. The ROM 20B stores in advance various control programs, various parameters, and the like. In the image forming device 12, the individual parts of the control unit 20 are electrically connected by a system bus 42.

The image forming device 12 according to the present exemplary embodiment also includes a hard disk drive (HDD) 26, which stores various types of data, application programs, and the like. The image forming device 12 further includes a display controller 28, which is connected to a user interface 22 and which controls displaying of various operation screens on a display of the user interface 22. In addition, the image forming device 12 includes an operation input detector 30, which is connected to the user interface 22 and which detects operation instructions input via the user interface 22. In the image forming device 12, the HDD 26, the display controller 28, and the operation input detector 30 are electrically connected to the system bus 42. Although an example in which the image forming device 12 according to the present exemplary embodiment includes the HDD 26 is discussed, this is not the only possible case, and the image forming device 12 may include a non-volatile memory such as flash memory.

Moreover, the image forming device 12 according to the present exemplary embodiment includes a reading controller 32, which controls the optical image reading operation of a document reader 46 and the document feed operation of a document feeder, and an image formation controller 34, which controls the image formation processing performed by an image forming unit 24 and the feeding of paper to the image forming unit 24 by a feeder 25. The image forming device 12 also includes a communication interface (communication UF) unit 36, which is connected to the internal communication line 17 and which transmits and receives communication data to and from other devices connected to the internal communication line 17, and an image processor 44, which performs various types of image processing. Moreover, the image forming device 12 includes a facsimile interface (facsimile UF) unit 38, which is connected to a phone line (not illustrated) and which transmits and receives facsimile data to and from facsimile machines connected to the phone line. The image forming device 12 also includes a transmission/reception controller 40, which controls transmission/reception of facsimile data via the facsimile interface unit 38. In the image forming device 12, the transmission/reception controller 40, the reading controller 32, the image formation controller 34, the communication line interface unit 36, the facsimile interface unit 38, and the image processor 44 are electrically connected to the system bus 42.

With the above configuration, the image forming device 12 according to the present exemplary embodiment executes, with the CPU 20A, access to the RAM 20C, the ROM 20B, and the HDD 26. Furthermore, the image forming device 12 executes control of, with the CPU 20A, displaying of information such as operation screens and various messages on the display of the user interface 22 via the display controller 28. The image forming device 12 also executes control of, with the CPU 20A, the operation of the document reader 46 and the document feeder via the reading controller 32. In addition, the image forming device 12 controls, with the CPU 20A, the operation of the image forming unit 24 and the feeder 25 via the image formation controller 34, and the transmission/reception of communication data via the communication line interface unit 36. In addition, the image forming device 12 executes control of, with the CPU 20A, the transmission/reception of facsimile data by the transmission/reception controller 40 via the facsimile interface unit 38. Furthermore, the image forming device 12 grasps, with the CPU 20A, operation contents of the user interface 22 based on operation information detected by the operation input detector 30, and executes various types of control based on the operation contents. Note that forming an image on paper may be referred to as printing.

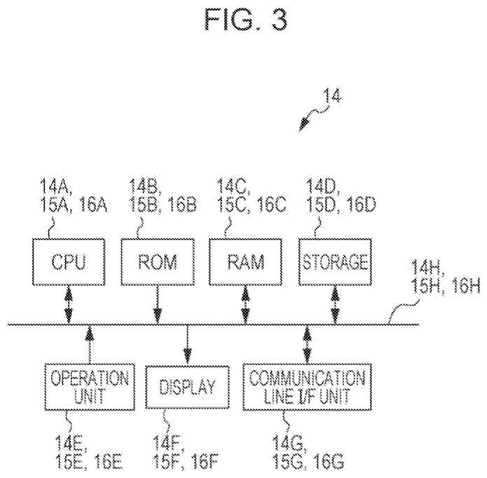

Next, the configuration of the major parts of the electrical system of the cloud server 14, the administrator terminals 15, and the communication terminal 16 in the image forming system 10 according to the present exemplary embodiment will be described. FIG. 3 is a block diagram illustrating the configuration of the major parts of the electrical system of the cloud server 14, one administrator terminal 15, and the communication terminal 16 according to the present exemplary embodiment. Since the cloud server 14, the administrator terminal 15, and the communication terminal 16 basically have the configuration of a general computer, the cloud server 14 will be described as a representative while omitting the description of the administrator terminal 15 and the communication terminal 16, and only corresponding reference symbols are indicated in FIG. 3.

The cloud server 14 according to the present exemplary embodiment includes, as illustrated in FIG. 3, a CPU 14A, a ROM 14B, a RAM 14C, a storage 14D, an operation unit 14E, a display 14F, and a communication line interface (UF) unit 14G. The CPU 14A controls the entire operation of the cloud server 14. The ROM 14B stores in advance an information processing program for performing various types of control, various parameters, and the like. The RAM 14C is used as a work area or the like when the CPU 14A executes various programs. The storage 14D stores various types of data, application programs, and the like. The operation unit 14E is used for inputting various types of information. The display 14F is used for displaying various types of information. The communication line interface unit 14G is connected to the external communication line 18, and transmits and receives various types of data to and from other devices connected to the external communication line 18. The above units of the cloud server 14 are electrically connected to each other by a system bus 14H. The cloud server 14 according to the present exemplary embodiment includes the storage 14D as a memory, and a non-volatile memory such as an HDD or flash memory is applied as the storage 14D. The storage 14D stores a worker database 300, which will be described later. Note that communication line interface units 15G and 16G of the administrator terminal 15 and the communication terminal 16 are connected to the internal communication line 17 and transmit and receive various types of data to and from other devices connected to the internal communication line 17.

With the above configuration, the cloud server 14 according to the present exemplary embodiment executes, with the CPU 14A, access to the ROM 14B, RAM 14C, and storage 14D, obtaining of various types of data via the operation unit 14E, and displaying of various types of information on the display 14F. The cloud server 14 also executes control of, with the CPU 14A, the transmission/reception of communication data via the communication line interface unit 14G.

In the image forming system 10 according to the present exemplary embodiment configured as above, for example, the image forming devices 12 and the administrator terminals 15 are provided in the company. Then, the use of each image forming device 12 is allowed from the outside using the communication terminal 16 via the cloud server 14.

The cloud server 14 provides the function of a virtual device that functions as an image forming device 12 in conjunction with the image forming device 12. That is, in the image forming system 10 according to the present exemplary embodiment, the CPU 14A on the cloud server 14 side functions as a virtual device that is provided one-to-one with a physical device, and that mediates the transmission/reception of information between an application and the physical device. In the following description, an image forming device 12 as an example of a physical device may be referred to as a real device 12.

A virtual device 50 synchronizes with the real device 12 with predetermined timing. An example of data to be synchronized includes meta data such as log data, status data, setting information, and machine information including a device name and a model name. When the virtual device 50 and the real device 12 are synchronized, it becomes possible to remotely view the status or change the settings of the real device 12 using the communication terminal 16 or the like.

Moreover, the virtual device 50 performs processing with external services via an application programming interface (API). Examples of external services include a machine management service and a printing service.

The machine management service allows a machine administrator who is at a different office or in a different country to access the machine management service to check the status or change the settings of the machine. The machine management service transmits and receives information to and from the virtual device 50. When the machine management service sends a status checking request to the virtual device 50, the virtual device 50 returns the status information. When the machine management service sends a setting change request to the virtual device 50, the virtual device 50 updates the setting information. When synchronized with the virtual device 50, the real device 12 obtains the updated setting information and changes the settings of the real device 12.

The printing service allows a mobile terminal such as the communication terminal 16 to upload print data to the printing service, and prints it on the real device 12 having obtained a print job via the virtual device 50.

By working on the virtual device 50 corresponding to the real device 12 without going to a place where the real device 12 is installed, the worker is able to perform maintenance work on the real device 12.

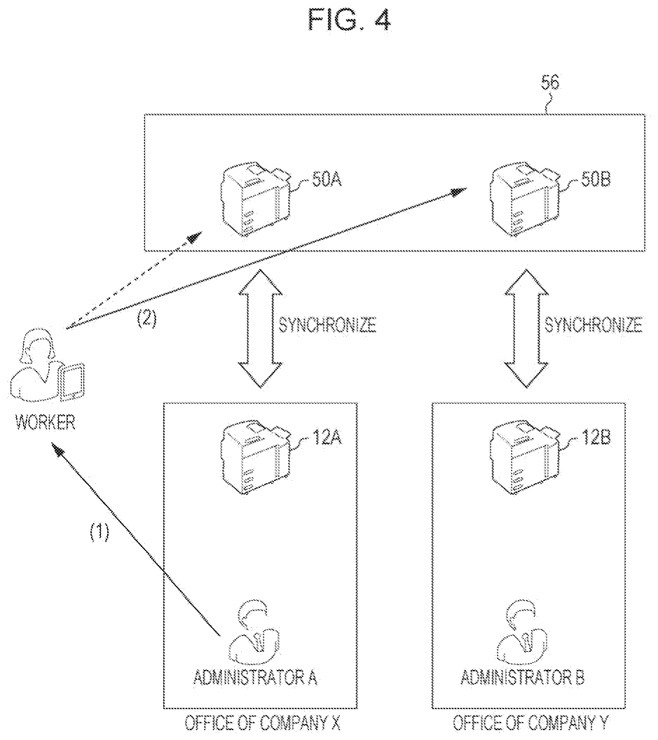

FIG. 4 illustrates a situation where the worker is permitted to work on a virtual device 50A and a virtual device 50B.

Upon acceptance of a maintenance instruction to perform maintenance work, the worker is able to work on the virtual device 50 corresponding to the real device 12 by following the following procedure.
(1) Administrator A who manages the real device 12A installed in the office of Company X instructs the worker to perform maintenance work on the real device 12A as a target device.
(2) The worker works on the virtual device 50A without going to the office of Company X, thereby performing maintenance work on the real device 12A. However, since this worker is also able to work on the virtual device 50B, there is a possibility that the worker accidentally works on the virtual device 50B.

Therefore, in the present exemplary embodiment, the information processing program stored in the cloud server 14 accepts a maintenance instruction for performing maintenance work on a target device, which is one of a plurality of image forming devices 12, permits a worker who is able to work on a plurality of virtual devices 50 to perform, as maintenance work, only work on a virtual device 50 corresponding to the target device, and prohibits the worker from working on a virtual device 50 corresponding to a non-target device other than the target device among the plurality of image forming devices 12.

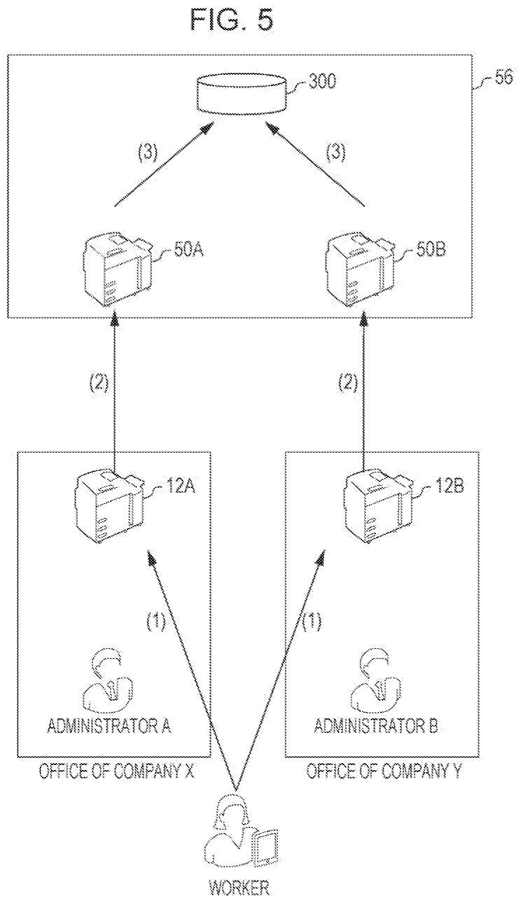

Next, processing performed in the image forming system 10 according to the present exemplary embodiment will be described. FIG. 5 is a diagram for explaining processing performed in the case where real devices 12 are newly installed.

When the real device 12A is installed in the office of Company X and the real device 12B is installed in the office of Company Y, the worker is able to work on the virtual device 50A corresponding to the real device 12A and the virtual device 50B corresponding to the real device 12B by following the following procedure.
(1) The worker registers worker information identifying the worker and contact information indicating the contact address of the communication terminal 16 carried by the worker in each of the real device 12A and the real device 12B.
(2) The worker generates the virtual device 50A corresponding to the real device 12A and the virtual device 50B corresponding to the real device 12B on a cloud 56.
(3) The virtual device 50 stores the worker information, the contact information, and physical device information identifying the real device 12, which are received from the real device 12, as well as virtual device information identifying the virtual device 50 in association with each other in the worker database 300.

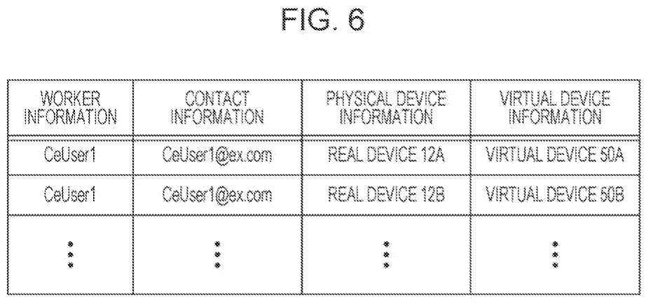

FIG. 6 illustrates the worker database 300. As illustrated in FIG. 6, the worker database 300 stores worker information, contact information, physical device information, and virtual device information in association with one another. In the example illustrated in FIG. 6, a worker identified by the worker information “CeUser1” is permitted to work on the virtual device 50A and the virtual device 50B. Note that an email address is applied as contact information in the example illustrated in FIG. 6. However, this example is not the only possible case. Alternatively, a phone number or the like may be applied as contact information.

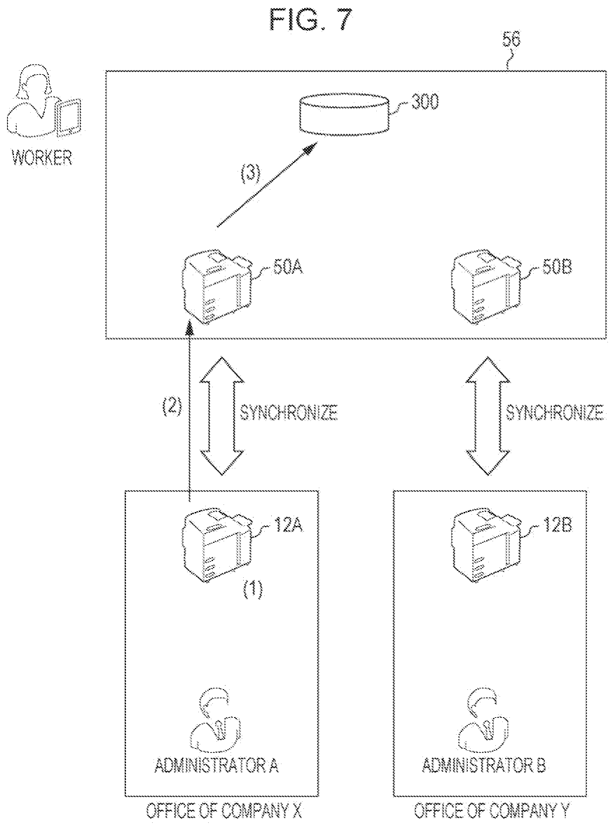

Next, a procedure in which the administrator instructs the worker to perform maintenance work on a target device will be described. FIG. 7 is a diagram illustrating processing performed in the case where administrator A instructs the worker to perform maintenance work on the real device 12A as a target device.

Administrator A instructs the worker to perform maintenance work on the real device 12A as a target device in accordance with the following procedure. Hereinafter, an instruction given by an administrator to a worker to perform maintenance work will be referred to as a maintenance instruction.
(1) Administrator A gives a maintenance instruction for the real device 12A via a user interface 22A of the real device 12A as a target device. Specifically, administrator A enters the content of the maintenance work, the period for which the work is permitted, and the range of settings and functions for which a connection is permitted into the user interface 22A. Hereinafter, the content of maintenance work for which an instruction is given by an administrator will be referred to as the instruction content, the period for which the work is permitted will be referred to as the specified period, and the range of settings and functions for which a connection is permitted will be referred to as the permitted range. The instruction content, the specified period, and the permitted range will be collectively referred to as instruction information.
(2) The real device 12A transmits, in addition to the instruction information whose entry has been accepted from the administrator, physical device information identifying the real device 12A to the virtual device 50A corresponding to the real device 12A.
(3) The virtual device 50A stores the instruction information and the situation in association with the physical device information identifying the real device 12A in the worker database 300. The situation is information indicating whether a worker according to worker information stored in association is prohibited or permitted to work on the virtual device 50A according to virtual device information. At the time point of (3), the virtual device 50A stores in the worker database 300 that, for a worker according to worker information stored in association, work on the virtual device 50A according to virtual device information is prohibited.

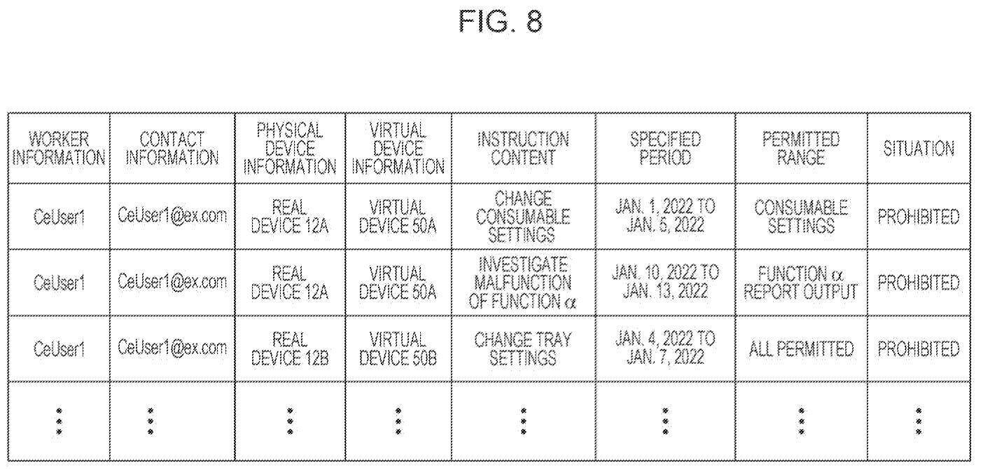

FIG. 8 illustrates the worker database 300 storing the instruction information. As illustrated in FIG. 8, the worker database 300 stores, in addition to the worker information, contact information, physical device information, and virtual device information, the instruction information and the situation in association with one another. In the present exemplary embodiment, “prohibited” is stored as the situation in the case where work on the virtual device 50 is prohibited, and “permitted” is stored as the situation in the case where work on the virtual device 50 is permitted.

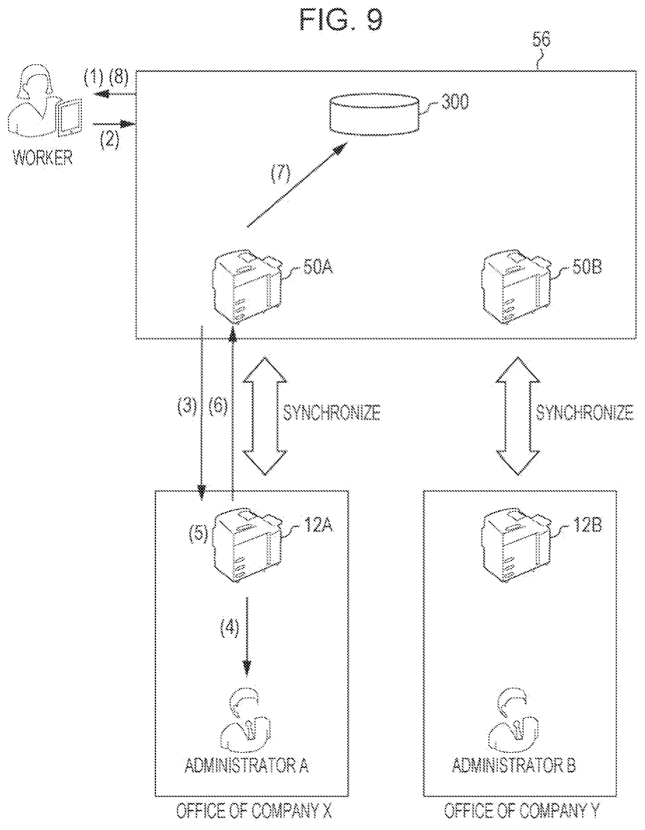

Next, the case in which the worker works on the virtual device 50A corresponding to the real device 12A will be described. FIG. 9 is a diagram for explaining the case in which the worker works on the virtual device 50A.

Upon storage of the instruction information in the worker database 300, the worker is enabled to work on the virtual device 50 corresponding to the target device by performing processing in accordance with the following procedure.
(1) The cloud server 14 notifies the communication terminal 16 of instruction information and virtual device information stored in association with the instruction information.
(2) The worker transmits, to the cloud server 14, an application for permission to perform, on the virtual device 50A according to the virtual device information whose notice has been given, work of the instruction content included in the instruction information whose notice has been given.
(3) The cloud server 14 transfers the application for permission to the real device 12A corresponding to the virtual device 50A according to the application for permission received from the communication terminal 16.
(4) The real device 12A transfers the application for permission received from the cloud server 14 to the administrator terminal 15A.
(5) Administrator A permits, via the user interface 22A of the real device 12A, work of the instruction content to be performed on the virtual device 50A according to the application for permission in the specified period.
(6) The real device 12A transmits to the virtual device 50A corresponding to the real device 12A that work of the instruction content is permitted to be performed on the virtual device 50A according to the application for permission in the specified period.
(7) The virtual device 50A updates the situation, which is stored in the worker database 300 in association with the instruction information according to the application for permission, from prohibited to permitted.
(8) The cloud server 14 notifies the communication terminal 16 that work of the instruction content is permitted to be performed on the virtual device 50A according to the application for permission in the specified period.

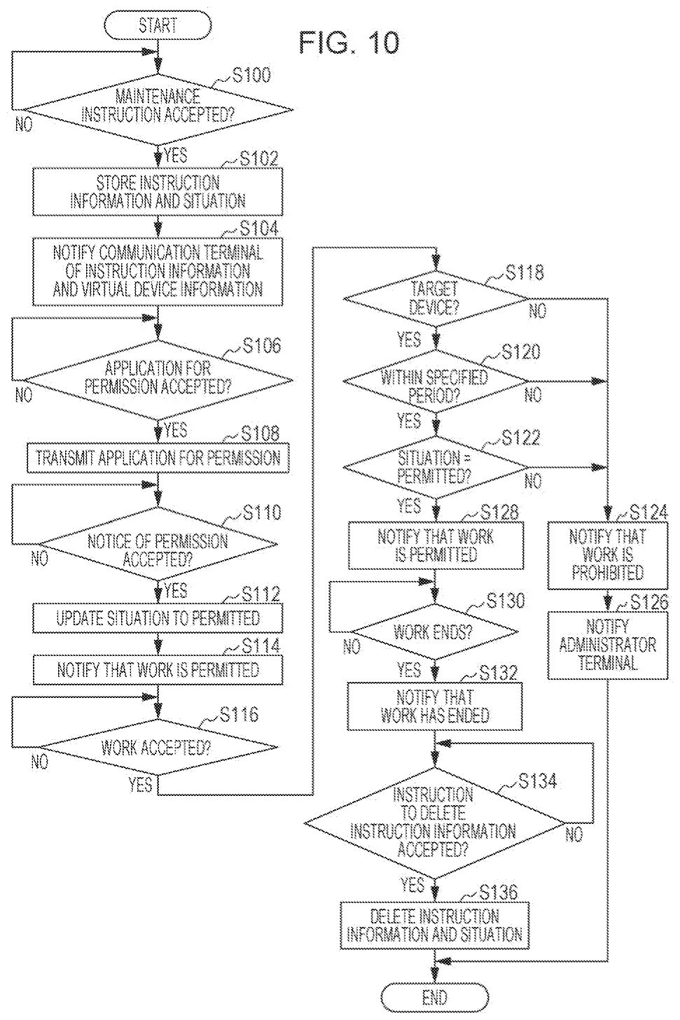

Next, specific processing performed by the cloud server 14 in the image forming system 10 according to the present exemplary embodiment configured as described above will be described. FIG. 10 is a flowchart illustrating an example of the flow of information processing performed by the cloud server 14 in the image forming system 10 according to the present exemplary embodiment. The CPU 14A reads the information processing program from the ROM 14B, and expands and executes it in the RAM 14C, thereby performing information processing. Note that the case in which the worker is permitted in advance to work on a plurality of virtual devices 50 will be described here.

In step S100, the CPU 14A waits until accepting a maintenance instruction from a target device, which is one of a plurality of real devices 12, to perform maintenance work on the target device.

In step S102, the CPU 14A stores, in the worker database 300, instruction information according to the maintenance instruction and the fact that the situation is prohibited in association with physical device information identifying the target device.

In step S104, the CPU 14A notifies the communication terminal 16 of the instruction information (instruction content, specified period, and permitted range) according to the maintenance instruction and virtual device information identifying the virtual device 50 corresponding to the target device.

In step S106, the CPU 14A waits until accepting, from the communication terminal 16, an application for permission to perform work of the instruction content included in the instruction information whose notice has been given on the virtual device 50 corresponding to the target device in the specified period. Upon acceptance of the application for permission from the communication terminal 16 (YES in step S106), the CPU 14A proceeds to step S108.

In step S108, the CPU 14A transmits the application for permission accepted from the communication terminal 16 to the target device.

In step S110, the CPU 14A waits until accepting, from the target device, a notice of permission for performing work of the instruction content on the virtual device 50 corresponding to the target device in the specified period. Upon acceptance of an instruction from the target device to permit work of the instruction content to be performed on the virtual device 50 corresponding to the target device in the specified period (YES in step S110), the CPU 14A proceeds to step S112.

In step S112, the CPU 14A updates, in the worker database 300, the situation stored in association with the instruction information according to the application for permission from prohibited to permitted.

In step S114, the CPU 14A notifies the communication terminal 16 that work of the instruction content is permitted to be performed on the virtual device 50 corresponding to the target device in the specified time.

In step S116, the CPU 14A waits until accepting work on any virtual device 50 from the communication terminal 16. In other words, the CPU 14A waits until the worker attempts to execute work on any virtual device 50. Upon acceptance of work on any virtual device 50 from the communication terminal 16 (YES in step S116), the CPU 14A proceeds to step S118.

In step S118, the CPU 14A determines whether the accepted work is work on the virtual device 50 corresponding to the target device. Specifically, the CPU 14A determines whether virtual device information identifying the virtual device 50 on which work has been accepted in step S116 is stored in advance in association with worker information identifying the worker in the worker database 300. In the case where the accepted work is work on the virtual device 50 corresponding to the target device (YES in step S118), the CPU 14A proceeds to step S120. In contrast, in the case where the accepted work is not work on the virtual device 50 corresponding to the target device (NO in step S118), that is, in the case where the accepted work is work on a virtual device 50 corresponding to a non-target device other than the target device, the CPU 14A proceeds to step S124.

In step S120, the CPU 14A determines whether the date and time at which the work has been accepted is within the specified period. Specifically, the CPU 14A determines whether the date and time at which the work has been accepted in step S116 is within the specified period stored in advance in association with the worker information identifying the worker and the virtual device information in the worker database 300. In the case where the date and time at which the work has been accepted is within the specified period (YES in step S120), the CPU 14A proceeds to step S122. In the case where the date and time at which the work has been accepted is outside the specified period (NO in step S120), the CPU 14A proceeds to step S124.

In step S122, the CPU 14A determines whether the situation is stored as permitted. Specifically, the CPU 14A determines whether the situation stored in association with the worker information identifying the worker, the specified period, and the virtual device information in the worker database 300 is stored as permitted. In the case where the situation is stored as permitted (YES in step S122), the CPU 14A proceeds to step S128. In contrast, in the case where the situation is not stored as permitted (NO in step S122), the CPU 14A proceeds to step S124.

In step S124, the CPU 14A notifies the communication terminal 16 that the work on the virtual device 50 is prohibited.

In step S126, the CPU 14A notifies the administrator terminal 15 owned by the administrator who manages the target device as a predetermined user that the worker has not executed the work on the virtual device 50 corresponding to the target device within the specified period. Then, the CPU 14A ends the information processing. That is, the CPU 14A prohibits the work on the virtual device 50 that the worker attempted to execute.

In step S128, the CPU 14A notifies the target device that the worker is permitted to work on the virtual device 50 corresponding to the target device within the specified time, and permits the work on the virtual device 50 that the worker attempted to execute.

In step S130, the CPU 14A waits until the worker ends the work on the virtual device 50 corresponding to the target device. When the worker ends the work on the virtual device 50 corresponding to the target device (YES in step S130), the CPU 14A proceeds to step S132.

In step S132, the CPU 14A notifies the administrator terminal 15 owned by the administrator who manages the target device that the worker has ended the work on the virtual device 50 corresponding to the target device.

In step S134, the CPU 14A waits until accepting an instruction from the administrator terminal 15 to delete the instruction information. Upon acceptance of an instruction from the administrator terminal 15 to delete the instruction information (YES in step S134), the CPU 14A proceeds to step S136.

In step S136, the CPU 14A deletes the instruction information and the situation according to the application for permission in the worker database 300. As a result of this processing, when the worker ends the work on the virtual device 50 corresponding to the target device, the CPU 14A is able to prohibit the worker from performing the permitted work on the virtual device 50. Then, the information processing ends.

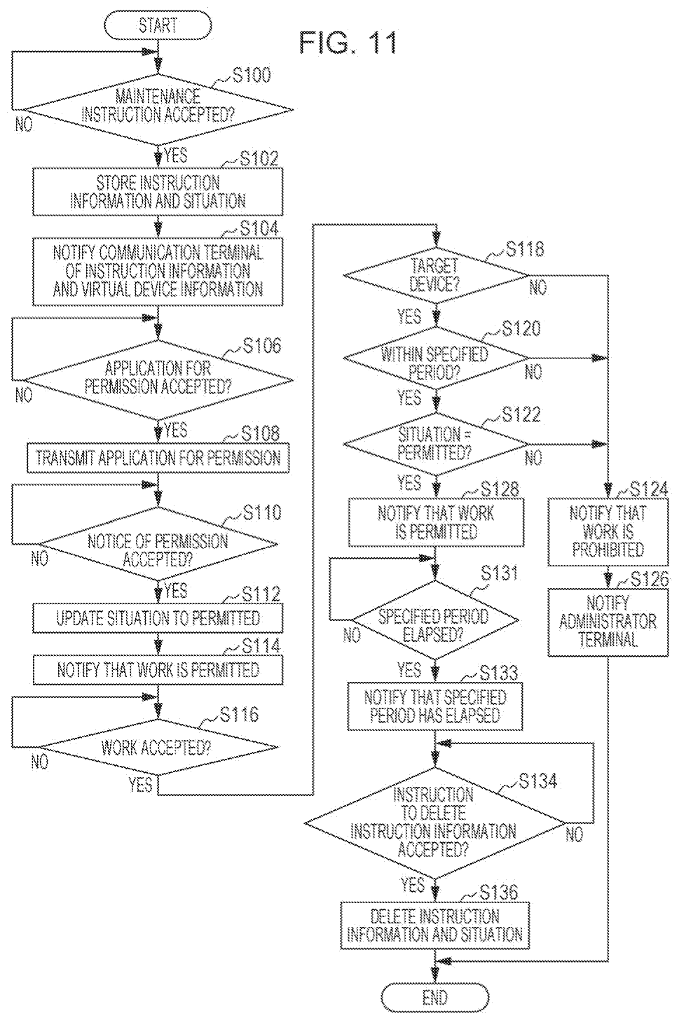

Although the example in which, when the worker ends the work on the virtual device 50 corresponding to the target device, the cloud server 14 prohibits the worker from performing the permitted work on the virtual device 50 has been described in the above exemplary embodiment, this is not the only possible case. For example, when the specified period has elapsed, the cloud server 14 may prohibit the worker from performing the permitted work on the virtual device 50. In this case, information processing in FIG. 11 is performed. FIG. 11 is a flowchart illustrating an example of the flow of a modification of the information processing performed by the cloud server 14 in the image forming system 10 according to the present exemplary embodiment. FIG. 11 differs from FIG. 10 in the point that steps S131 and S133 are applied instead of steps S130 and S132 in the information processing illustrated in FIG. 10.

In step S131, the CPU 14A waits until the specified period has elapsed. When the specified period has elapsed (YES in step S131), the CPU 14A proceeds to step S133.

In step S133, the CPU 14A notifies the administrator terminal 15 owned by the administrator who manages the target device that the specified period has elapsed.

Note that, in the above exemplary embodiment, the cloud server 14 accepts a maintenance instruction from the administrator who manages the real device 12 via the user interface 22A. However, this example is not the only possible case. Alternatively, the cloud server 14 may accept a maintenance instruction from a user who uses the real device 12 via the user interface 22A. Moreover, the cloud server 14 may accept a maintenance instruction from the administrator terminal 15 owned by the administrator who manages the real device 12.

In the above exemplary embodiment, after accepting the maintenance instruction, when the cloud server 14 accepts a notice of permission for work to be performed on the virtual device 50 corresponding to the target device in the specified period, the cloud server 14 permits the worker to perform the work. However, this example is not the only possible case. Regardless of whether the notice has been accepted from the target device, the cloud server 14 may permit the work to be performed on the virtual device 50 corresponding to the target device in the specified period.

In the above exemplary embodiment, a maintenance instruction includes a specified period for which work on the virtual device 50 is permitted. However, this example is not the only possible case. A maintenance instruction need not include a specified period.

In the above exemplary embodiment, the cloud server 14 notifies the administrator who manages the target device when the worker attempts to execute work on a virtual device 50 corresponding to a non-target device. However, this example is not the only possible case. The cloud server 14 notifies the administrator who manages the non-target device when the worker attempts to execute work on a virtual device 50 corresponding to a non-target device. In the case where the user who uses the real device 12 gives a maintenance instruction, the cloud server 14 may notify the user when the worker attempts to execute work on a virtual device 50 corresponding to a non-target device. In this case, the cloud server 14 may display, on the user interface 22A of the target device, that the worker has not executed the work on the virtual device 50 corresponding to the target device in the specified period

In the above exemplary embodiment, after the specified period has elapsed or after the worker has ended the work on the virtual device 50 corresponding to the target device, when an instruction to delete the instruction information is accepted from the administrator terminal 15, the cloud server 14 deletes the instruction information. However, this example is not the only possible case. After the specified period has elapsed or after the worker has ended the work on the virtual device 50 corresponding to the target device, regardless of whether the above instruction has been received from the administrator terminal 15, the cloud server 14 may delete the instruction information.

Although the image forming devices 12 have been described as an example of physical devices in the above exemplary embodiment, physical devices are not limited to the image forming devices 12. For example, other devices such as image processing devices may be applied as physical devices.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In addition, processing performed by each unit of the image forming system 10 according to the above exemplary embodiment may be processing performed by software, processing performed by hardware, or processing that combines both. Moreover, processing performed by each unit of the image forming system 10 may be stored as a program on a storage medium to be distributed.

The present disclosure is not limited to the above, and needless to say, in addition to the above, the present disclosure may be implemented in various modifications within a range not deviating from the gist thereof.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) An information processing program causing a computer to execute a process, the process including:
   accepting a maintenance instruction for performing maintenance work on a target device which is one of a plurality of physical devices; and
   permitting a worker who is able to work on a plurality of virtual devices provided one-to-one with the plurality of physical devices to perform, as the maintenance work, only work on a virtual device corresponding to the target device, and prohibiting the worker from working on a virtual device corresponding to a non-target device other than the target device among the plurality of physical devices.
(((2))) The information processing program according to (((1))), wherein the process includes permitting the worker to work on the virtual device corresponding to the target device in a period specified in the maintenance instruction, and prohibiting the worker from working on the virtual device corresponding to the target device outside the specified period.
(((3))) The information processing program according to (((2))), wherein the process includes prohibiting the worker from performing the permitted work on the virtual device when the specified period has elapsed.
(((4))) The information processing program according to (((1))) or (((2))), wherein the process includes prohibiting the worker from performing the permitted work on the virtual device when the worker ends the work on the virtual device corresponding to the target device.
(((5))) The information processing program according to any one of (((1))) to (((4))), wherein the process includes notifying a predetermined user when the worker attempts to execute work on the virtual device corresponding to the non-target device.
(((6))) The information processing program according to (((5))), wherein the process includes notifying an administrator of the target device when the worker attempts to execute work on the virtual device corresponding to the non-target device.
(((7))) The information processing program according to any one of (((1))) to (((6))), wherein the process includes, upon acceptance of the maintenance instruction, notifying the worker of content of the maintenance work according to the maintenance instruction.
(((8))) The information processing program according to any one of (((1))) to (((7))), wherein the process includes permitting the work in a case where virtual device information identifying the virtual device on which the worker works is stored in advance in association with worker information identifying the worker, and prohibiting the work in a case where the virtual device information is not stored in advance in association with the worker information.
(((9))) An information processing system including:
   an information processing device storing the information processing program according to any one of (((1))) to (((8))); and
   the plurality of physical devices.

What is claimed is:

1. A non-transitory computer readable medium storing a program causing a computer to execute a process for information processing, the process comprising:
accepting a maintenance instruction for performing maintenance work on a target device which is one of a plurality of physical devices; and
permitting a worker who is able to work on a plurality of virtual devices provided one-to-one with the plurality of physical devices to perform, as the maintenance work, only work on a virtual device corresponding to the target device, and prohibiting the worker from working on a virtual device corresponding to a non-target device other than the target device among the plurality of physical devices.

2. The non-transitory computer readable medium according to claim 1, wherein the process includes permitting the worker to work on the virtual device corresponding to the target device in a period specified in the maintenance instruction, and prohibiting the worker from working on the virtual device corresponding to the target device outside the specified period.

3. The non-transitory computer readable medium according to claim 2, wherein the process includes prohibiting the worker from performing the permitted work on the virtual device when the specified period has elapsed.

4. The non-transitory computer readable medium according to claim 1, wherein the process includes prohibiting the worker from performing the permitted work on the virtual device corresponding to the target device when the worker ends the work on the virtual device.

5. The non-transitory computer readable medium according to claim 1, wherein the process includes notifying a predetermined user when the worker attempts to execute work on the virtual device corresponding to the non-target device.

6. The non-transitory computer readable medium according to claim 5, wherein the process includes notifying an administrator of the target device when the worker attempts to execute work on the virtual device corresponding to the non-target device.

7. The non-transitory computer readable medium according to claim 1, wherein the process includes, upon acceptance of the maintenance instruction, notifying the worker of content of the maintenance work according to the maintenance instruction.

8. The non-transitory computer readable medium according to claim 1, wherein the process includes permitting the work in a case where virtual device information identifying the virtual device on which the worker works is stored in advance in association with worker information identifying the worker, and prohibiting the work in a case where the virtual device information is not stored in advance in association with the worker information.

9. An information processing system comprising:
an information processing device storing the information processing program according to claim 1; and
the plurality of physical devices.
